(19) United States
(12) Patent Application Publication
(10) Pub. No.: US 2026/0125245 A1
(43) Pub. Date: May 7, 2026

(54) LIFTING SYSTEM FOR LIFTING A MONOPILE, A CRADLE, A VESSEL AND A METHOD OF STORING A MONOPILE ON A VESSEL

(71) Applicant: IQIP HOLDING B.V., Sliedrecht (NL)

(72) Inventors: Quintus Wilhelmus Petrus Maria Zuijdgeest, Zoetermeer (NL); David Goedknegt, Oud-Beijerland (NL)

(21) Appl. No.: 19/118,269

(22) PCT Filed: Sep. 21, 2023
(86) PCT No.: PCT/NL2023/050488

§ 371 Date: Apr. 3, 2025

(30) Foreign Application Priority Data
Oct. 6, 2022 (NL) 2033252

(51) Int. Cl. B66C 1/16; B63B 27/10; B63B 35/00

(52) U.S. Cl. CPC B66C 1/16; B63B 27/10; B63B 35/003

(57) ABSTRACT

A lifting system (1) for lifting a monopile (3, 6) comprises a pair of coupling members (2) for being coupled to a monopile at a distance from each other in longitudinal direction of the monopile. Each of the coupling members has a support (7) for being coupled to a hoisting apparatus, such as a crane (21), a sling (8) for at least partly surrounding a monopile, which sling is suspended from the support thus forming a loop and a tightening device (14) for varying the length of the sling.

### CROSS-REFERENCE TO RELATED APPLICATIONS

This Application is a Section 371 National Stage Application of International Application No. PCT/NL2023/050488, filed Sep. 21, 2023 and published as WO 2024/076231 A1 on Apr. 11, 2024, in English.

### BACKGROUND

The present invention relates to a lifting system for lifting a monopile.

Offshore wind turbines may be installed on top of monopiles which are driven into the seabed. Usually, the monopiles are manufactured at an onshore location and loaded to a vessel at a quay. The monopiles are transferred from the quay to the vessel by means of a crane and stored in a horizontal orientation on a deck of the vessel. The crane has hoisting cables from which a spreader beam is suspended. Prior to lifting a monopile, two slings are connected around the monopile and the slings are attached to the spreader beam. After the monopile is placed onto the deck the slings are disconnected from the monopile and connected to another monopile that will be transferred from the quay to the vessel. After placing the monopiles on the deck, the vessel sails to an offshore site where the monopiles will be installed into the seabed. At the offshore site a crane on the vessel can lift a stored monopile after connecting the same spreader beam or a different one including the two slings or different ones to it and transfer it to an upending device which is used to turn the monopile to a vertical orientation. Subsequently, the monopile may be displaced to a location of the vessel where the monopile is lowered to the seabed and driven into the seabed by means of a pile driver. A disadvantage of the above-described operations is that they take a lot of time at the offshore site.

### SUMMARY

A lifting system for lifting a monopile comprises a pair of coupling members for being coupled to a monopile at a distance from each other in longitudinal direction of the monopile, wherein each of the coupling members has a support for being coupled to a hoisting apparatus, such as a crane, a sling for at least partly surrounding a monopile, which sling is suspended from the support thus forming a loop and a tightening device for varying the length of the loop.

An advantage of the lifting system according to the invention is that the coupling members are relatively simple mechanical structures which can be connected to a monopile before loading it to a vessel, for example at a quay, and can remain on the monopile until it is placed on an upending device of the vessel. The supports can be used to be temporarily fixed to the vessel such that the monopile hangs from the supports by the slings, for example during transport of the monopile to an offshore site. The tightening device provides the opportunity to clamp the sling about a monopile by shortening the length of the loop. This means that the coupling members may function as sea fastening tools. At the offshore site the monopile can be easily lifted by connecting a hoisting member to the supports, hence obviating time-consuming operations of fastening slings to each of the monopiles. The support and the sling of the coupling member may be adapted such that when shortening the loop the monopile is clamped against the support.

The coupling members may be separate units.

The sling may be mounted or releasably mountable to the support at a first location and a second location thereof, which first and second locations are located at a distance from each other. This means that a monopile may be clamped between the sling and the support at each of the coupling members when shortening the loop of the sling.

The sling may comprise an endless element which is looped about the support at the first location and at the second location. In this case the loop of the sling, i.e. a portion of the endless element that can support a monopile, is formed by two sections of the sling.

In a particular embodiment at the second location the sling is looped about two stationary sling guides which are located at a distance from each other in a plane, wherein the tightening device comprises a dynamic sling guide for guiding the sling between the stationary sling guides, wherein the dynamic sling guide is movable with respect to the stationary sling guides in transverse direction of the plane. The dynamic sling guide may be operated by an actuator. The stationary sling guides may be pins.

At the second location the sling may be looped about two stationary sling guides which are located at a distance from each other. The stationary sling guides at the second location may be pins.

The support may be rigid.

The support may be an elongate element, for example a beam made of steel.

The lifting system may be provided with a hoisting member for being coupled to a hoisting apparatus, which hoisting member is releasably attachable to the supports, In case the coupling members are separate units, they are preferably applied on a monopile at a fixed distance from each other, since the hoisting member may have fixed dimensions.

The hoisting member may comprise a rectangular frame having two opposite sides which are releasably attachable to the respective supports.

The invention is also related to a cradle for receiving a monopile including the lifting system as described hereinbefore, wherein the supports fit to cooperating receivers of the cradle. This is advantageous since a monopile can be easily placed in the cradle and lifted from the cradle without disconnecting the coupling members from the monopile.

In a preferred embodiment the stationary sling guides at the first and second locations may fit to the receivers, since in this case the stationary sling guides have two functions: for guiding the sling and for being received by the receivers of the cradle.

The invention is also related to a vessel, comprising a deck and a cradle, which cradle is movable across the deck.

The cradle may be movable in longitudinal direction and lateral direction of the deck, in longitudinal direction for storing monopiles, for example at a distance from a crane on the vessel, and in lateral direction in order to be able to vary the location of the center of gravity of the monopile in transverse direction of the vessel.

The invention is also related to a method of storing a monopile on a vessel including a cradle as described hereinbefore by using the lifting system as described hereinbefore, wherein the slings are mounted around the monopile and attached to the respective supports at a distance from each other along the monopile to form respective loops of the slings about the monopile, the respective tightening devices are operated to shorten the loops of the slings until the distances between the supports and the monopile are at desired distances, a hoisting member is connected to the supports after which the supports including the slings and the monopile are lifted and transferred to the cradle where the supports are placed at the receivers and the hoisting member is disconnected from the supports. In the resulting stored condition of the monopile the cradle bears the supports, which in turn bear the monopile through the respective slings. When the vessel sails to an offshore site for installing the stored monopile, the supports can be easily coupled to a hoisting member and lifted in order to transfer the monopile to an upending device, for example. At the upending device the coupling members can be disconnected from the monopile by operating the tightening devices and removing the supports and the slings from the monopile.

### BRIEF DESCRIPTION OF THE DRAWINGS

The invention will hereafter be elucidated with reference to the schematic drawings showing an embodiment of the invention by way of example.

FIG. 1 is a perspective view of an embodiment of a lifting system, showing a monopile which is lifted by the lifting system and located above a cradle,

FIG. 2 is a similar view as FIG. 1, showing a condition in which the monopile is received by the cradle.

FIG. 3 is a similar view as FIG. 2, showing another condition.

FIG. 4 is a similar view as FIG. 3, showing a condition in which two monopiles are received by the cradle.

FIG. 5 is a front view of a coupling member of the lifting system as shown in FIG. 1.

FIG. 6 is a side view of the coupling member in the direction VI in FIG. 5.

FIG. 7 is a similar view as FIG. 6, showing the coupling member in the direction VII in FIG. 5.

FIG. 8 is a similar view as FIG. 7, but showing a different condition of the coupling member.

FIG. 9 is a similar view as FIG. 5, but showing a different condition of the coupling member.

FIG. 10 is a top view of an embodiment of a vessel.

FIG. 11 is a similar view as FIG. 10, showing a different condition of the vessel.

FIG. 12 is a similar view as FIG. 10, showing still another condition of the vessel.

### DETAILED DESCRIPTION OF THE ILLUSTRATIVE EMBODIMENTS

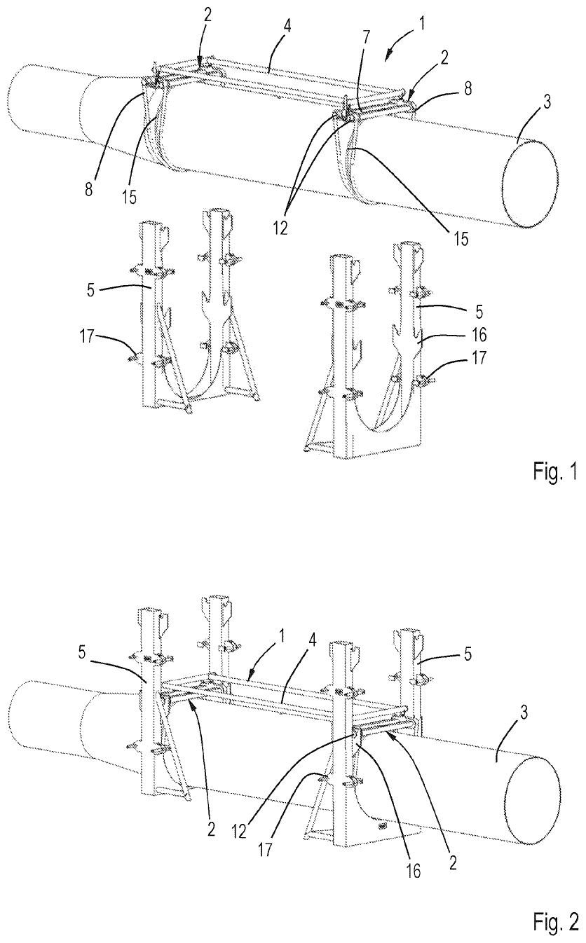

FIG. 1 shows an embodiment of a lifting system 1 according to the invention. The lifting system 1 comprises a pair of coupling members 2 which are coupled to a monopile 3 at a distance from each other in longitudinal direction of the monopile 3. In the condition as shown in FIG. 1 the coupling members 2 are attached to a hoisting member 4 which in turn is suspended from a crane (not shown). FIG. 1 shows that the monopile 3 is located above a cradle 5.

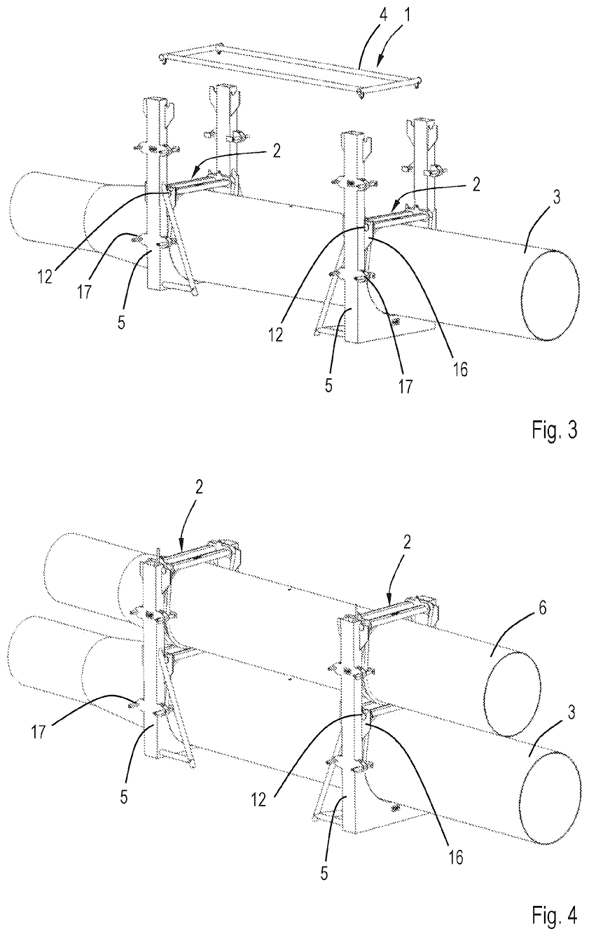

FIG. 2 shows a condition in which the monopile 3 is lowered and received by the cradle 5. In this condition the coupling members 2 are supported by the cradle 5. The cradle 5 is shown as two separate U-shaped frames, but they may be attached to each other. FIG. 3 shows that after positioning the monopile 3 in the cradle 5 the hoisting member 4 is detached from the coupling members 2, for example by means of a pin release mechanism, and lifted with respect to the monopile 3 and the cradle 5. FIG. 4 shows a condition in which another monopile 6 is received by the cradle 5 and positioned above the monopile 3 such that the cradle 5 comprises a stack of two monopiles 3, 6.

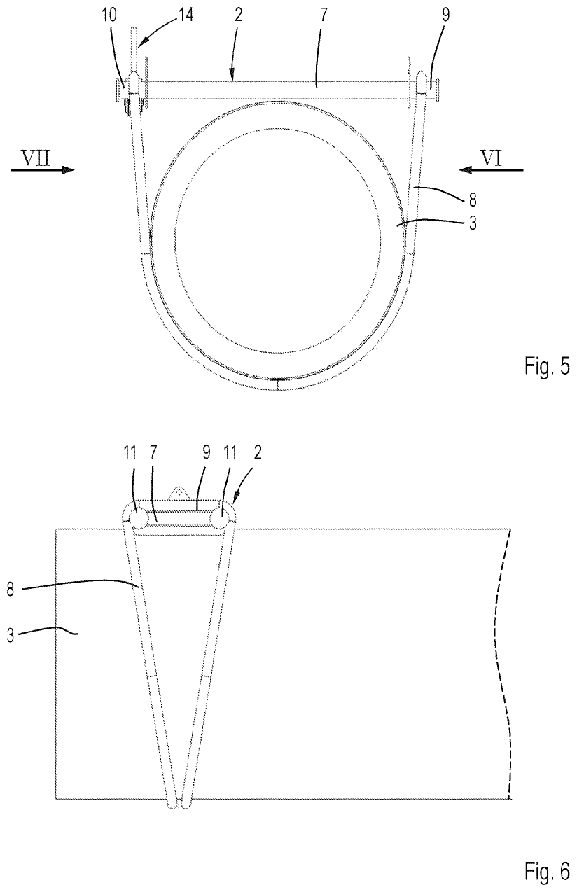

FIG. 5 shows one of the coupling members 2. It has a rigid support 7 and a sling 8 which is suspended from the support 7 and partly surrounds the monopile 3. The sling 8 forms a loop about the monopile 3. The support 7 is an elongate element in the form of a beam, for example made of steel. The sling 8 comprises a flexible endless element, for example a rope or cable, which has loops at a first location 9 and at a second location 10 of the support 7. The first location 9 and the second location 10 are located at opposite end portions of the support 7. FIG. 6 shows that at the first location 9 the sling 8 is looped about two pins 11 of the support 7.

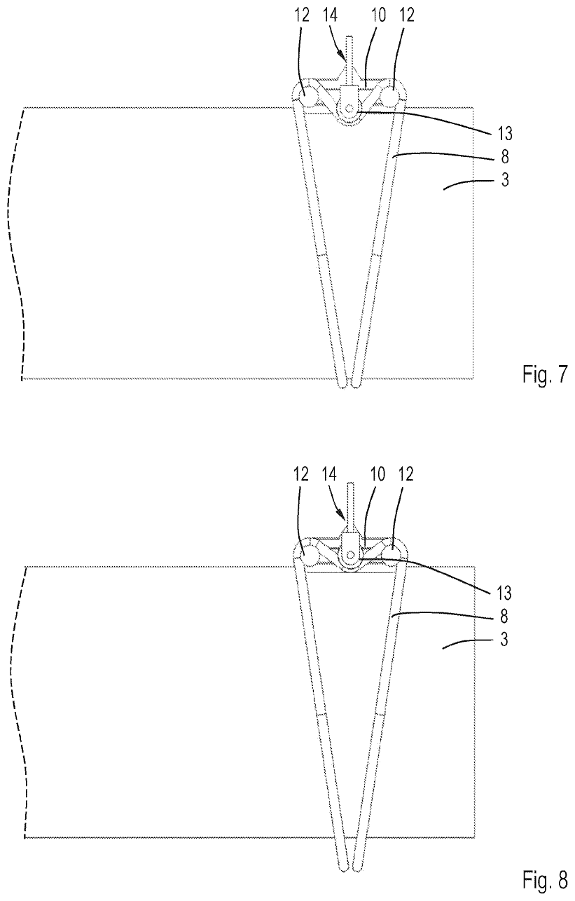

FIG. 7 shows that at the second location 10 the sling 8 is looped about two stationary sling guides 12 in the form of pins which are located at a distance from each other in the horizontal plane. Between the stationary sling guides 12 the sling 8 is guided by a dynamic sling guide 13 in the form of a freely rotatable wheel. The dynamic sling guide 13 is movable with respect to the stationary sling guides 12 perpendicularly to the horizontal plane by means of an actuator (not shown) in order to vary the length of the loop of the sling 8 about the monopile 3. In this way a tightening device 14 for connecting the sling 8 and the support 7 about the monopile 3 is created.

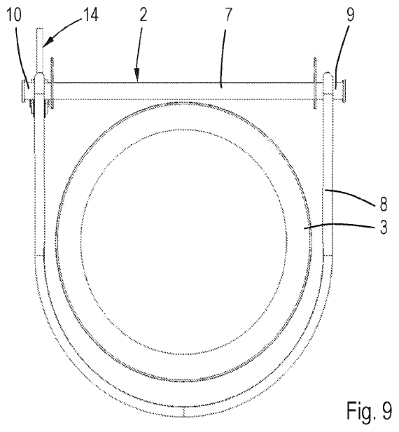

The latter condition is shown in FIGS. 5-7, whereas FIGS. 8 and 9 show a condition in which the tightening device 14 is de-activated such that the sling 8 is slack. Consequently, the support 7 and the sling 8 do not clamp about the monopile 3, which condition can be used to couple or decouple the coupling member 2 to the monopile 3.

Referring to FIGS. 1-4 the hoisting member 4 is releasably attachable to the supports 7. In the embodiment as shown the hoisting member 4 has a rigid rectangular frame. The frame is provided with releasing mechanisms at the respective corners thereof in order to enable to engage the supports 7.

In practice the monopile 3 may be provided with indicators, e.g. lines 15 as shown in FIG. 1, where the coupling members 2 should be placed such that the hoisting member 4 can engage the supports 7 correctly.

FIGS. 1-4 show that the cradle 5 is provided with upwardly directed hooks 16 which define receivers for receiving the pins 11 and the stationary sling guides 12 of the supports 7. Furthermore, the cradle 5 is provided with additional retaining members 17 which engage the monopile 3 in its final position in the cradle 5 so as to lock the monopile 3 with respect to the cradle 5 in horizontal direction.

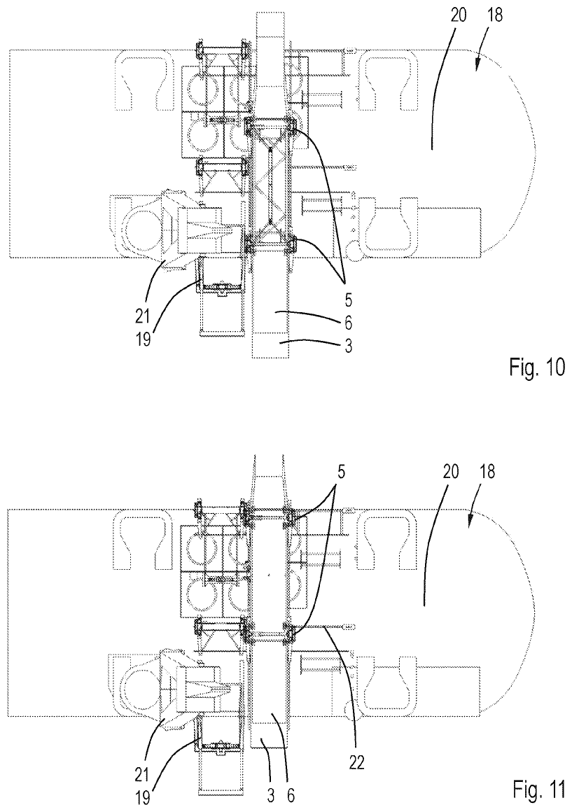

FIG. 10 illustrates that the cradle 5 including the monopiles 3, 6 as shown in FIG. 4 is located on a vessel 18 for transporting monopiles to an offshore site where they are installed in the seabed, for example for mounting wind turbines on top of the monopiles. The monopiles are transported in a horizontal orientation and upended at the offshore site by an upending device 19. The cradle 5 is movable across a deck 20 of the vessel 18 in order to move the monopiles to be upended close to a crane 21 which is also mounted on the deck 20. The cradle 5 can be displaced in longitudinal direction of the vessel 18 in order to use space on the deck 20 at a distance from the crane 21 for storage of the monopiles 3, 6 and in transverse direction in order to move the centers of gravity of the cradle 5 including the monopiles 3, 6 to or close to a longitudinal center plane of the vessel 18. For that reason, the deck 20 is provided with rails 22 for guiding the cradle 5, see FIG. 11.

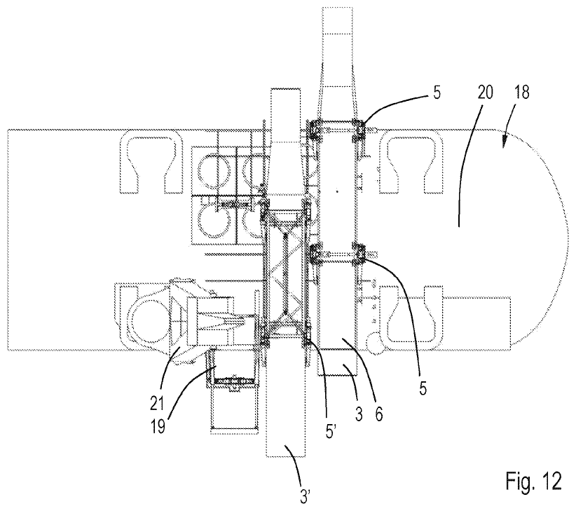

FIG. 10 illustrates that the monopiles 3, 6 are loaded from a quay (not shown) to the cradle 5 when the cradle 5 is located at or displaced to starboard side and FIG. 11 shows that the cradle 5 including the monopiles 3, 6 is moved towards port side thereafter. Before leaving to the offshore site a number of cradles 5 may be loaded with monopiles and stored on the deck 20. FIG. 12 illustrates that another cradle 5′ is loaded with a monopile 3′, whereas the loaded cradle 5 is displaced away from the crane 21.

At the offshore site each of the cradles 5, 5′ can be transferred towards the crane 21 such that it can lift the stored monopiles 3, 6 after coupling the hoisting member 4 to each pair of supports 7 that are mounted to the respective monopiles.

From the above it is clear that the presence of the coupling members minimizes operation time at the offshore site since it is not necessary to connect slings to each of the monopiles.

The invention is not limited to the embodiment shown in the drawings and described hereinbefore, which may be varied in different manners within the scope of the claims and their technical equivalents. For example, in an alternative embodiment the sling may have a different shape, such as a single rope having loops at its opposite ends. Furthermore, the tightening device and the manner of mounting the sling to the support may be different in an alternative embodiment. It is also conceivable that the lifting system is provided with supports that are fixed to each other and are located at a distance from each other instead of having coupling members as separate units,

1. A lifting system for lifting a monopile, comprising:
a pair of coupling members configured to be coupled to a monopile at a distance from each other in a longitudinal direction of the monopile, wherein each of the coupling members comprises:
a support configured to be coupled to a hoisting apparatus;
a sling configured to at least partly surround the monopile, which sling is suspended from the support thus forming a loop; and
a tightening device configured to vary a length of the loop.

2. The lifting system according to claim 1, wherein the coupling members are separate units.

3. The lifting system according to claim 1, wherein each sling is mounted or releasably mountable to the respective support at a first location and a second location thereof, which first and second locations are located at a distance from each other.

4. The lifting system according to claim 3, wherein each sling comprises an endless element which is looped about the respective support at the first location and at the second location.

5. The lifting system according to claim 4, wherein at the second location each sling is looped about two stationary sling guides which are located at a distance from each other in a plane, wherein each tightening device comprises a dynamic sling guide configured to guide the respective sling between the respective stationary sling guides, wherein the dynamic sling guide is movable with respect to the respective stationary sling guides in a transverse direction of the respective plane.

6. The lifting system according to claim 5, wherein at the first location each sling is looped about two stationary sling guides which are located at a distance from each other.

7. The lifting system according to claim 1, wherein each support is rigid.

8. The lifting system according to claim 1, wherein each support is an elongate element.

9. The lifting system according to claim 1, wherein the lifting system is provided with a hoisting member configured to be coupled to a hoisting apparatus, which hoisting member is releasably attachable to the supports.

10. The lifting system according to claim 9, wherein the hoisting member comprises a rectangular frame having two opposite sides which are releasably attachable to the respective supports.

11. A cradle for receiving a monopile lifted by a lifting system comprising a pair of coupling members configured to be coupled to the monopile at a distance from each other in a longitudinal direction of the monopile, wherein each of the coupling members comprises a support configured to be coupled to a hoisting apparatus and a sling configured to at least partly surround the monopile, which sling is suspended from the support thus forming a loop, wherein the cradle comprises a frame with cooperating receivers configured to fit the supports.

12. The cradle according to claim 11, wherein the receivers for each support comprise a first pair of hooks and a second pair of hooks spaced apart from the first pair of hooks.

13. A vessel, comprising:
a deck;
a cradle movable across the deck, the cradle being configured to receive and support a monopile. wherein the cradle includes receivers; and
a lifting system for lifting the monopile, comprising:
a pair of coupling members configured to be coupled to the monopile at a distance from each other in a longitudinal direction of the monopile, wherein each of the coupling members comprises:
a support configured to be coupled to a hoisting apparatus:
a sling configured to at least partly surround a monopile, which sling is suspended from the support thus forming a loop; and
a tightening device configured to vary a length of the loop.

14. The vessel, according to claim 13, wherein the cradle is movable in a longitudinal direction and a lateral direction of the deck.

15. A method of storing a monopile on a vessel using a cradle with receivers and a lifting system having a pair of coupling members, wherein each of the coupling members has a support and a sling to at least partly surround the monopile, the method comprising:
mounting each sling around the monopile and attaching each sling to the respective support, the slings being at a distance from each other along the monopile and forming respective loops about the monopile;
shortening each of the loops of the slings until distances between the supports and the monopile are at desired distances;
connecting a hoisting member to the supports;
lifting and transferring the supports including the slings and the monopile and to the cradle with the hoisting member where the supports are placed at the receivers; and
disconnecting the hoisting member from the supports.

16. The method according to claim 15,
wherein mounting each sling comprises mounting each sling to the respective support at a first location and a second location thereof, which first and second locations are located at a distance from each other, and wherein at the second location each sling is looped about two stationary sling guides which are located at a distance from each other in a plane, and
wherein shortening comprises moving a dynamic sling guide that engages a portion of each respective sling between the respective stationary sling guides in a transverse direction to each respective plane.

17. The vessel according to claim 13, wherein each sling is mounted or releasably mountable to the respective support at a first location and a second location thereof, which first and second locations are located at a distance from each other.

18. The lifting system according to claim 17, wherein each sling comprises an endless element which is looped about the respective support at the first location and at the second location.

19. The lifting system according to claim 18, wherein at the second location each sling is looped about two stationary sling guides which are located at a distance from each other in a plane, wherein each tightening device comprises a dynamic sling guide configured to guide the respective sling between the respective stationary sling guides, wherein the dynamic sling guide is movable with respect to the respective stationary sling guides in a transverse direction of the plane.

20. The lifting system according to claim 19, wherein at the first location each sling is looped about two stationary sling guides which are located at a distance from each other.
